(19) United States
(12) Patent Application Publication
(10) Pub. No.: US 2026/0001147 A1
(43) Pub. Date: Jan. 1, 2026

(54) TWIST DRILL WITH LONG LIFE AND EASY CUTTING

(71) Applicant: DANYANG JIANLU TOOLS CO., LTD., Zhenjiang, Jiangsu (CN)

(72) Inventor: Ning JIANG, Zhenjiang, Jiangsu (CN)

(21) Appl. No.: 18/258,446

(22) PCT Filed: May 6, 2023
(86) PCT No.: PCT/CN2023/092391

§ 371 Date: May 12, 2025

(30) Foreign Application Priority Data
Sep. 23, 2022 (CN) 202222524501.2

(51) Int. Cl. B23B 51/02

(52) U.S. Cl. CPC B23B 51/02; B23B 2251/40

(57) ABSTRACT

A twist drill with long life and easy cutting, is provided with a vertical discharge chute on a major cutting edge. The cutting part of the twist drill comprises a major cutting edge, a side cutting edge, discharge chutes and a back chute ridge, the left side of the major cutting edge is provided with the side cutting edge, the discharge chutes comprise a vertical discharge chute and a horizontal discharge chute, the vertical discharge chute is arranged on the major cutting edge, the horizontal discharge chute is arranged on the side cutting edge, the horizontal discharge chute and the vertical discharge chute are interconnected, the fluting angle of the vertical discharge chute is perpendicular to the edge of the back chute ridge, and a horizontal discharge chute is added on the side of the major cutting edge, which is originally provided with a discharge chute at the drill tip.

### TECHNICAL FIELD

The present invention belongs to the technical field of high-speed twist drills, and particularly relates to a twist drill with long life and easy cutting.

### BACKGROUND

With the development of science and technology and the continuous updating of structure, a complex structure needs to be fixed by screw parts inside. When the structure is fixed, it is necessary to drill holes in the fixed position of the structure. In this case, bits are required to drill holes to facilitate the installation of the structure. Due to the continuous development of science and technology, the variety of bits is also increasing. The twist bit is one of bits, and the traditional twist bit has the following defects:

When drilling a hole, the existing twist bit will produce much sweeps, and most of the sweeps are distributed around the drilled hole, which is not easy to observe the drilling situation, thus affecting the use of the bit. The traditional twist bit is not able to remove the surrounding sweeps quickly and orderly. In the working process of the twist bit, the sweeps produced may also enter from the top end of the twist bit due to the flow of air, which will affect the rotation efficiency of the twist bit. The existing twist bit is not able to clean up and guide out the incoming sweeps.

An invention application No. 202222524501.2 proposes a twist drill with stable chip guiding, which is provided with a discharge chute on a major cutting edge. The cutting part of the twist drill comprises a major cutting edge, a discharge chute and a back chute ridge, the discharge chute is arranged on the major cutting edge, the fluting angle of the discharge chute is perpendicular to the edge of the back chute ridge, the back chute ridge has a shape of convex arc, a guide chute is arranged between the back chute ridge and the major cutting edge, material chips cut by the major cutting edge are steadily discharged from the guide chute by enlarging the discharge chute originally arranged on the major cutting edge, and the back chute ridge which is convex can keep the chips in the guide chute steadily so that the twist drill can make the chips move steadily in the guide chute to be guided out while working, which causes no problem of splashing or winding, facilitates the use of operators and improves the cutting efficiency of the twist drill in another way.

However, for the existing twist drill with stable chip guiding, the bit cannot be used for a long time when the stable chip guiding guide is guaranteed. Due to wearing and overheating of the drill tip and accumulation of molten materials after long-term drilling, the drilling time is gradually increased, and the chips produced are in a shape of continuous strips, which will cause the chips to be not guided out smoothly, reduce the quality of drilled holes, and result in drilling lines on the inner wall of the hole to reduce the smoothness, as shown in FIG. 4 and FIG. 6.

### SUMMARY

To solve the above problems, the present invention proposes a twist drill with long life and easy cutting, which is provided with a vertical discharge chute on a major cutting edge, wherein the cutting part of the twist drill comprises a major cutting edge, a side cutting edge, discharge chutes and a back chute ridge, the left side of the major cutting edge is provided with the side cutting edge, the discharge chutes comprise a vertical discharge chute and a horizontal discharge chute, the vertical discharge chute is arranged on the major cutting edge, the horizontal discharge chute is arranged on the side cutting edge, the horizontal discharge chute and the vertical discharge chute are interconnected, the fluting angle of the vertical discharge chute is perpendicular to the edge of the back chute ridge, a guide chute is arranged below the major cutting edge, the side cutting edge and the back chute ridge, and a horizontal discharge chute is added on the side of the major cutting edge, which is originally provided with a discharge chute at the drill tip, to assist chip discharge and cut coiled chips so that chips still can be discharged in a spirally curled shape after the bit is used for a long time, so as to extend the service life of the twist drill, increase the drilling speed and improve the quality of drilled holes.

The vertical discharge chute is a vertical arc-shaped chute, the vertical discharge chute is oppositely arranged on the major cutting edge on both sides of the twist drill, the upper end side of the vertical discharge chute is connected with the major cutting edge, the lower end side of the vertical discharge chute is connected with the guide chute, the left side of the vertical discharge chute is connected with the horizontal discharge chute, the right side of the vertical discharge chute is connected with the back chute ridge, the horizontal discharge chute is a horizontal arc-shaped chute, the horizontal discharge chute is oppositely arranged on the side cutting edge on both sides of the twist drill, the right end side of the horizontal discharge chute is connected with the vertical discharge chute, the upper side edge of the vertical discharge chute is connected with the side cutting edge, the lower side edge of the vertical discharge chute is connected with the guide chute, the horizontal discharge chute and the vertical discharge chute which are connected are matched to realize spirally curled discharge of chips, which can effectively reduce the production of long and flat chips, the matching of the major cutting edge and the side cutting edge also can realize the function of cutting chips, which can prevent long chips from winding the bit, increase the drilling efficiency and the drilling speed, improve the quality of drilled holes, and ensure the consistent smoothness of the inner wall, and the plurality of discharge chutes can improve the sharpness of the major cutting edge, thus reducing the cutting resistance.

The back chute ridge is a concave arc-shaped edge, the left side of the back chute ridge is connected with the major cutting edge, and the lower side of the back chute ridge is connected with the guide chute, so as to help chips to be guided out steadily and spirally in the guide chute and prevent the chips from splashing out of the guide chute, thus increasing the guiding efficiency without chip accumulation and increasing the cutting efficiency.

The guide chute is a spiral concave flute, one side of the guide chute is connected with the front face of the bit of the side cutting edge, the other side of the guide chute is connected with a minor cutting edge, the top end of the guide chute is in transitional connection with the horizontal discharge chute and the vertical discharge chute by cutting, the guide chute is in transitional connection with the front face of the bit through the discharge chute, and the front face is in perfect transitional connection with the guide chute through the arc-shaped discharge chute so that the cut chips can enter the guide chute directly to prevent the accumulation of chips on the end of the bit so as to increase the cutting efficiency.

### Beneficial Effects

A horizontal discharge chute is added on the side of the major cutting edge, which is originally provided with a discharge chute at the drill tip, to assist chip discharge and cut coiled chips so that chips still can be discharged in a granular form after the bit is used for a long time, so as to extend the service life of the twist drill and increase the drilling speed.

The horizontal discharge chute and the vertical discharge chute which are connected are matched to realize spirally curled discharge of chips, which can effectively reduce the production of long and flat chips, the matching of the major cutting edge and the side cutting edge also can realize the function of cutting chips, which can prevent long chips from winding the bit, increase the drilling efficiency and the drilling speed, improve the quality of drilled holes, and ensure the consistent smoothness of the inner wall, and the plurality of discharge chutes can improve the sharpness of the major cutting edge, thus reducing the cutting resistance.

To help chips to be guided out steadily and spirally in the guide chute and prevent the chips from splashing out of the guide chute, thus increasing the guiding efficiency without chip accumulation and increasing the cutting efficiency.

The front face is in perfect transitional connection with the guide chute through the arc-shaped discharge chute so that the cut chips can enter the guide chute directly to prevent the accumulation of chips on the end of the bit so as to increase the cutting efficiency.

### DESCRIPTION OF DRAWINGS

FIG. 1 is a schematic diagram of a twist drill with long life and easy cutting;

FIG. 2 is a local amplified schematic diagram of a drill tip of a twist drill with long life and easy cutting;

FIG. 3 is a top view of a twist drill with long life and easy cutting;

FIG. 4 shows data of actual drilling time of an existing twist drill and a novel twist drill shown in the present invention;

FIG. 5 is a picture of chips produced by drilling with a twist drill of the present invention;

FIG. 6 is a picture of chips produced by drilling with an existing twist drill;

FIG. 7 shows data of actual drilling number of times and drilling time of a twist drill;

In the figures: 1. drill stem, 2. side cutting edge, 3. major cutting edge, 4. back chute ridge, 5. vertical discharge chute, 6. horizontal discharge chute, and 7 guide chute.

### DETAILED DESCRIPTION

To deepen the understanding of the present invention, the present invention will be further described below in detail in combination with an embodiment and drawings. The embodiment is only used to explain the present invention, and does not constitute a limitation to the protection scope of the present invention.

Drill stem 1, side cutting edge 2, major cutting edge 3, back chute ridge 4, vertical discharge chute 5, horizontal discharge chute 6, and guide chute 7.

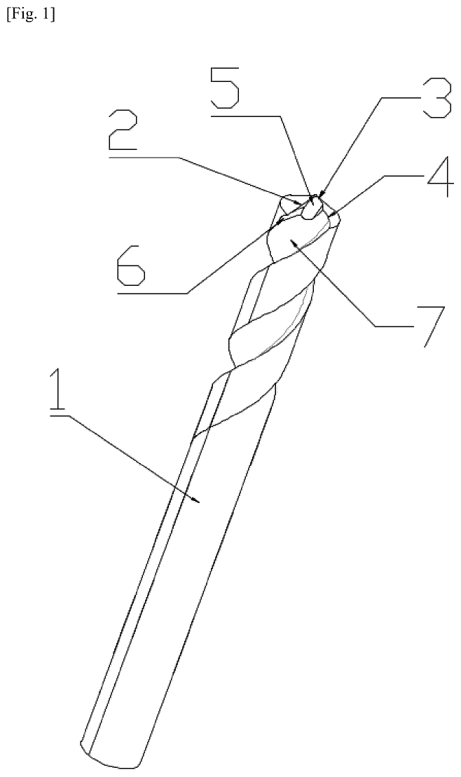

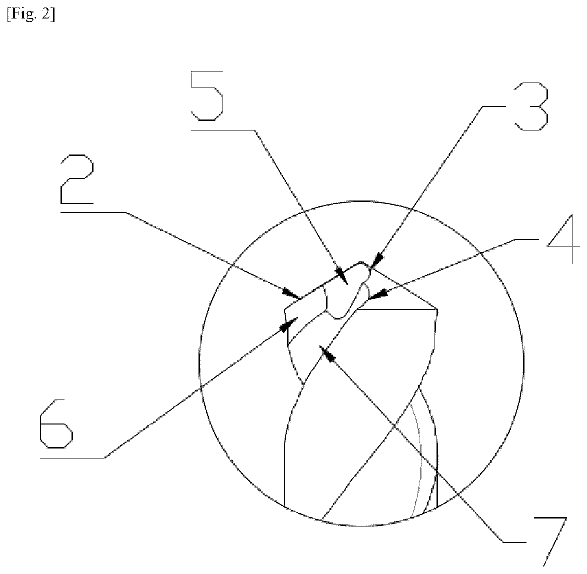

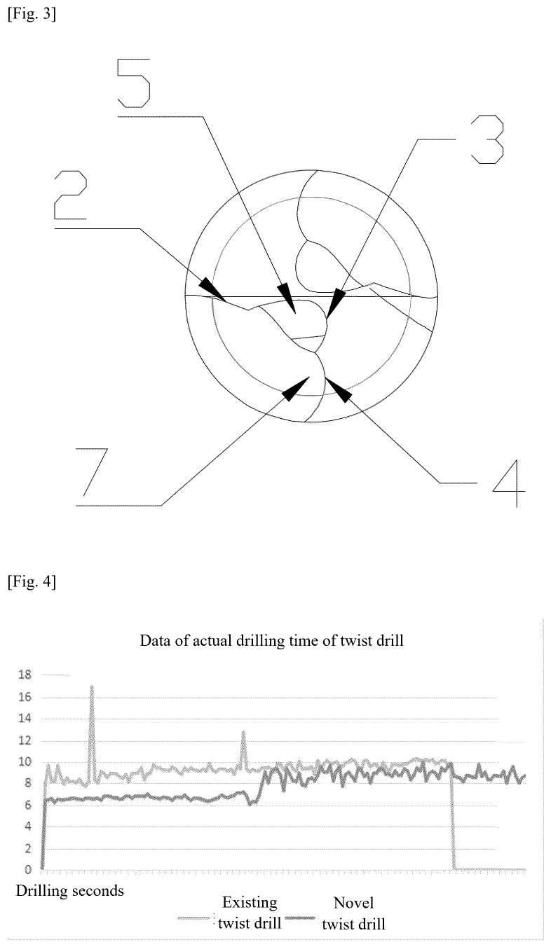

As shown in FIG. 1, FIG. 2 and FIG. 3;

A twist drill with long life and easy cutting, which is provided with a vertical discharge chute on a major cutting edge 3, wherein the cutting part of the twist drill comprises a major cutting edge 3, a side cutting edge 2, discharge chutes and a back chute ridge 4, the left side of the major cutting edge 3 is provided with the side cutting edge 2, the discharge chutes comprise a vertical discharge chute 5 and a horizontal discharge chute 6, the vertical discharge chute 5 is arranged on the major cutting edge 3, the horizontal discharge chute 6 is arranged on the side cutting edge 2, the horizontal discharge chute 6 and the vertical discharge chute 5 are interconnected, the fluting angle of the vertical discharge chute 5 is perpendicular to the edge of the back chute ridge 4, a guide chute 7 is arranged below the major cutting edge 3, the side cutting edge 2 and the back chute ridge 4, the vertical discharge chute 5 is a vertical arc-shaped chute, the vertical discharge chute 5 is oppositely arranged on the major cutting edge 3 on both sides of the twist drill, the upper end side of the vertical discharge chute 5 is connected with the major cutting edge 3, the lower end side of the vertical discharge chute 5 is connected with the guide chute 7, the left side of the vertical discharge chute 5 is connected with the horizontal discharge chute 6, the right side of the vertical discharge chute 5 is connected with the back chute ridge 4, the horizontal discharge chute 6 is a horizontal arc-shaped chute, the horizontal discharge chute 6 is oppositely arranged on the side cutting edge 2 on both sides of the twist drill, the right end side of the horizontal discharge chute 6 is connected with the vertical discharge chute 5, the upper side edge of the vertical discharge chute 5 is connected with the side cutting edge 2, the lower side edge of the vertical discharge chute 5 is connected with the guide chute 7, the back chute ridge 4 is a concave arc-shaped edge, the left side of the back chute ridge 4 is connected with the major cutting edge 3, the lower side of the back chute ridge 4 is connected with the guide chute 7, the guide chute 7 is a spiral concave flute, one side of the guide chute 7 is connected with the front face of the bit of the side cutting edge 2, the other side of the guide chute 7 is connected with a minor cutting edge, the top end of the guide chute 7 is in transitional connection with the horizontal discharge chute 6 and the vertical discharge chute 5 by cutting, and the guide chute 7 is in transitional connection with the front face of the bit through the discharge chute.

### Embodiment

When the twist drill is used for cutting, the major cutting edge 3 cuts the material in a rotary form, and the cut chips are guided into the horizontal discharge chute 6 through the vertical discharge flute 5 and spirally curled by matching of the horizontal discharge chute 6 and the side cutting edge 2 to form thin spirally curled chips so that the chips can be discharged steadily along the guide flute 7.

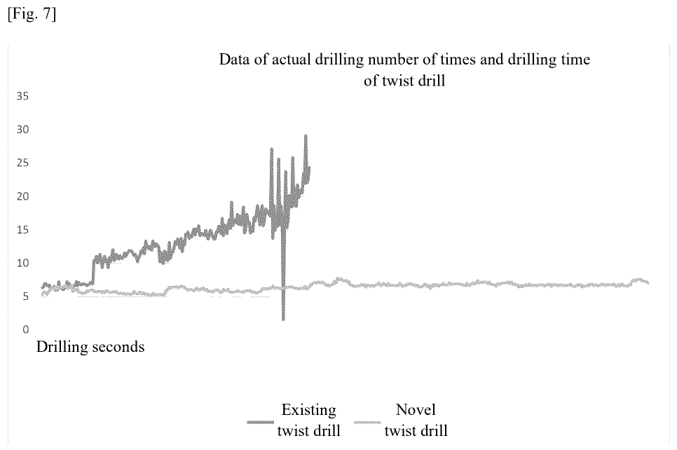

The existing twist drill and the twist drill of the present invention are compared by test instruments through multiple drilling experiments, obtaining comparison data as shown in FIG. 4, from which it can be clearly seen that the twist drill of the present invention can greatly shorten the drilling time at an early stage, has obvious advantages over the existing twist drill in the drilling speed at a later stage and also has obvious advantages in chip discharge and drilling number as shown in FIG. 7.

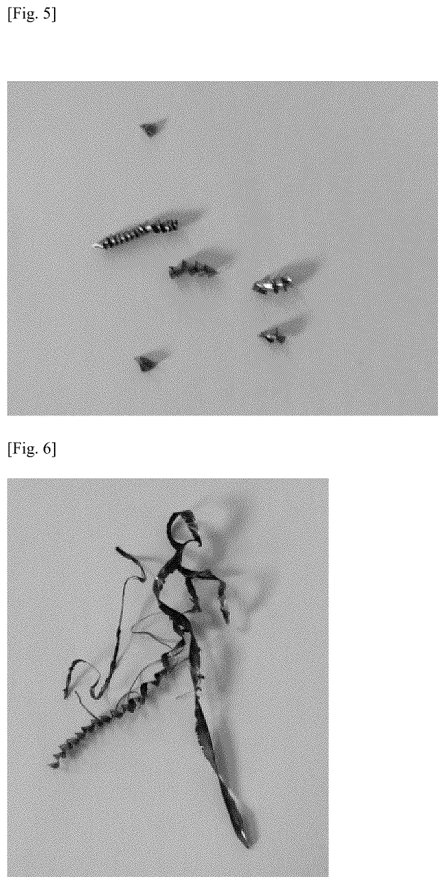

As shown in FIG. 5 and FIG. 6, after completing the final drilling experiment, the chips produced by the existing twist drill are in a shape of spiral strips, while the chips produced by the twist drill of the present invention are always in a spirally curled state.

The above is just a preferred embodiment of the present invention and is not intended to limit the present invention. Any modification, equivalent replacement, improvement, etc. made within the spirit and the principle of the present invention shall be contained within the protection scope of the present invention.

1. A twist drill with long life and easy cutting, which is provided with a vertical discharge chute on a major cutting edge, wherein the cutting part of the twist drill comprises a major cutting edge, a side cutting edge, discharge chutes and a back chute ridge, the left side of the major cutting edge is provided with the side cutting edge, the discharge chutes comprise a vertical discharge chute and a horizontal discharge chute, the vertical discharge chute is arranged on the major cutting edge, the horizontal discharge chute is arranged on the side cutting edge, the horizontal discharge chute and the vertical discharge chute are interconnected, the fluting angle of the vertical discharge chute is perpendicular to the edge of the back flute edge, and a guide chute is arranged below the major cutting edge, the side cutting edge and the back chute ridge.

2. The twist drill with long life and easy cutting according to claim 1, wherein the vertical discharge chute is a vertical arc-shaped chute, the vertical discharge chute is oppositely arranged on the major cutting edge on both sides of the twist drill, the upper end side of the vertical discharge chute is connected with the major cutting edge, the lower end side of the vertical discharge chute is connected with the guide chute, the left side of the vertical discharge chute is connected with the horizontal discharge chute, and the right side of the vertical discharge chute is connected with the back chute ridge.

3. The twist drill with long life and easy cutting according to claim 1, wherein the horizontal discharge chute is a horizontal arc-shaped chute, the horizontal discharge chute is oppositely arranged on the side cutting edge on both sides of the twist drill, the right end side of the horizontal discharge chute is connected with the vertical discharge chute, the upper side edge of the vertical discharge chute is connected with the side cutting edge, and the lower side edge of the vertical discharge chute is connected with the guide chute.

4. The twist drill with long life and easy cutting according to claim 1, wherein the back chute ridge is a concave arc-shaped edge, the left side of the back chute ridge is connected with the major cutting edge, and the lower side of the back chute ridge is connected with the guide chute.

5. The twist drill with long life and easy cutting according to claim 1, wherein the guide chute is a spiral concave flute, one side of the guide chute is connected with the front face of the bit of the side cutting edge, and the other side of the guide chute is connected with a minor cutting edge.

6. The twist drill with long life and easy cutting according to claim 1, wherein the top end of the guide chute is in transitional connection with the horizontal discharge chute and the vertical discharge chute by cutting, and the guide chute is in transitional connection with the front face of the bit through the discharge chute.
